(19) United States
(12) Patent Application Publication
(10) Pub. No.: US 2015/0108129 A1
(43) Pub. Date: Apr. 23, 2015

(54) Cover for a Cooking Tray

(71) Applicant: Darren LANGSTON, Walsall (GB)

(72) Inventor: Darren Langston, Walsall (GB)

(21) Appl. No.: 14/403,064

(22) PCT Filed: May 21, 2013
(86) PCT No.: PCT/GB2013/000230

§ 371 Date: Nov. 21, 2014

(30) Foreign Application Priority Data
May 24, 2012 (GB) 1209135.1

(51) Int. Cl. A47J 36/06

(52) U.S. Cl. CPC A47J 36/06
USPC 220/212.5

(57) ABSTRACT

A cover (101) for use with a cooking tray (102), The cover (101) is so locatable relative to the cooking tray (102) as to form a self-supporting roof thereover. The cover (101) has a surface having an upper side (202) and an underside (203) and defines a plurality of apertures (103) enabling vapour to pass therethrough. Each of the apertures (103) has a pair of edges (205, 206). At least one of the pair of edges (205, 206) of each aperture (103) extends inwardly or outwardly relative to the surface of the cover (101).

### FIELD OF THE INVENTION

The present invention relates to a cover for a cooking tray.

### BACKGROUND OF THE INVENTION

When cooking food in an oven, or other similar device, it is often desirable to cover the food either during or after the cooking process. This could be to avoid food juices or other fluids from contaminating surrounding areas, such as the internal surfaces of an oven, during or after the cooking process. It could also be to avoid the surface of the food becoming burnt due to too much direct heat on the food surface. Alternatively, it could be to prevent the food from drying out, if, for example, the food product needs to be cooked for an extended period of time.

Certain foods need to rest after the cooking process has ended. During this time, it can be necessary to cover up the food product to avoid it becoming undesirably cold. It may also be desirable to cover up a resting food product for the protective purposes.

A commonly used product to cover up food, both during and after the cooking process, is metallic foil, such as aluminium foil. However, using metallic foil to cover up food products carries with it certain disadvantages. Firstly, the surface of the food product may not reach a desired level of browning or crispness during cooking, thus reducing a person's enjoyment of the product. To attain the desired level of crispness, a person has to remove the metallic foil for a period of the cooking time, which requires a person to monitor the cooking process. Further, the use of a metallic foil to cover a food product, either during or after the cooking process, can undesirably result in the surface of the food product becoming soggy due to the presence of moisture retained inside the foil cover.

There is accordingly a need for a cover that can be used during cooking to prevent fluids from the food product being cooked from contaminating the surrounds surfaces of the cooking apparatus. There is also a need for a cover that can be used during cooking to prevent the surface of the food stuff being cooked from becoming burnt. There is further a need for a cover that can be used both during and after cooking of a food product that allows excess moisture to escape, thereby avoiding the surface of the food product from becoming soggy. There is additionally a need for a cover that will help to keep a food product warm after cooking, so that the food product does not become undesirably cold.

### SUMMARY OF THE INVENTION

According to a first aspect there is provided a cover for use with a cooking tray, said cover so locatable relative to said cooking tray as to form a self-supporting roof thereover, said cover having a surface having an upper side and an underside and defining a plurality of apertures enabling vapour to pass therethrough, each of said plurality of apertures having a pair of edges, and wherein at least one edge of said pair of edges extends inwardly or outwardly relative to the surface of the cover.

In an embodiment, one of said pair of side edges extends substantially in the same plane as the surface of the cover and the other of said pair of edges extends inwardly relative to the surface of the cover.

In an embodiment, one of said pair of side edges extends substantially in the same plane as the surface of the cover and the other of said pair of edges extends outwardly relative to the surface of the cover.

In an embodiment, one of said pair of side edges extends inwardly relative to the surface of the cover and the other of said pair of edges extends outwardly relative to the surface of the cover.

In an embodiment, the cover comprises at least one handle for facilitating manual handling thereof.

1. A cover as claimed in claim 12, comprising a pair of handles.

In an embodiment, a region of the cover does not define any apertures therein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows a cover for a cooking tray, arranged for use with the cooking tray;

FIG. 2 shows the cover mounted on the cooking tray and with a food product located within the space between the cover and the cooking tray;

FIG. 3 shows cover mounted on the cooking tray, in use within an oven;

FIG. 4 illustrates the functionality of the cover when in use;

FIG. 5 shows a second cover for a cooking tray;

FIG. 6 shows a third cover for a cooking tray;

FIG. 7 shows a fourth cover for a cooking tray; and

FIG. 8 shows different arrangements of a pair of edges of an aperture defined by a cover for a cooking tray.

### DETAILED DESCRIPTION OF THE EMBODIMENTS

There will now be described by way of example a specific mode contemplated by the inventor. In the following description numerous specific details are set forth in order to provide a thorough understanding. It will be apparent however, to one skilled in the art, that the present invention may be practiced without limitation to these specific details. In other instances well known methods and structures are not described in detail, so as not to unnecessarily obscure the description.

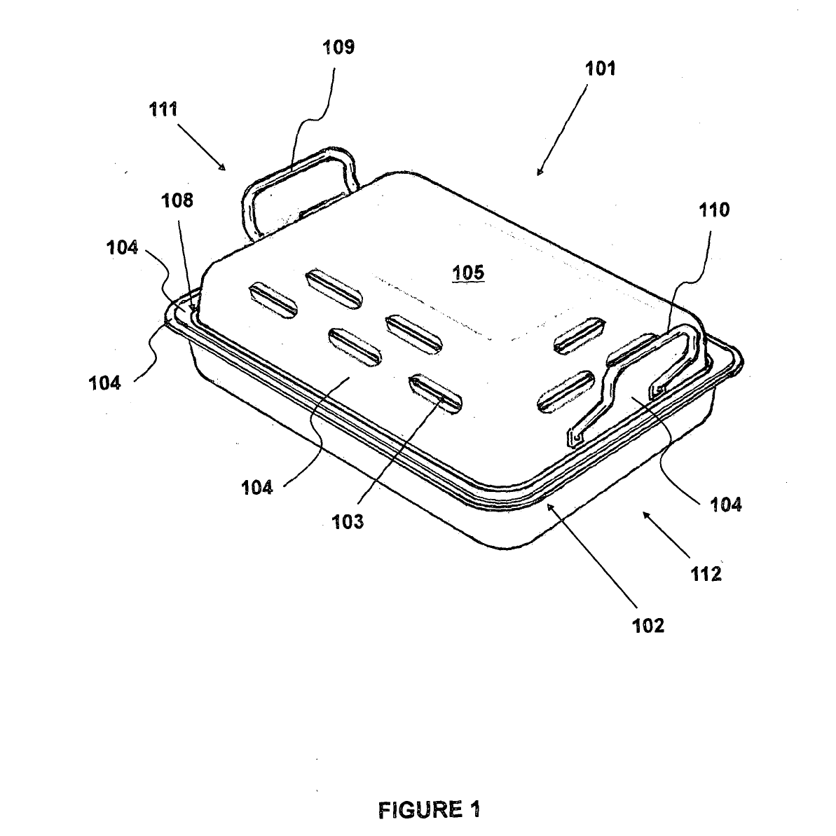

FIG. 1

A cover 101 for a cooking tray is shown in FIG. 1. The cover 101 is shown arranged for use with cooking tray 102. The cover 101 is so locatable relative to the cooking tray 102 as to form a self-supporting roof thereover. In this embodiment, the cover is mountable on the cooking tray. The term ‘mountable on’ is used herein to refer to any configuration of the cooking tray and the cover wherein the cover is positioned so as to be resting directly or indirectly within or on the cooking tray.

As will be described in further detail, the cover 101 defines a plurality of apertures 103. The cover 101 is configured to prevent fluids from escaping the cooking tray 102, whilst allowing excess moisture to escape. The function of the cover 101 to prevent fluids from escaping the cooking tray 102 advantageously prevents escaping fluid from contaminating surrounding surfaces, in turn reducing the need or the frequency of the need to clean those surfaces. This feature is particularly beneficial to reduce the cleaning demand of the inside surfaces of an oven, which can often be hard to reach and/or clean. The function of the cover 101 to vent excess moisture from the cooking tray 102 advantageously prevents the food from becoming undesirably soggy. This feature is particularly beneficial when cooking a food product for which a crispy surface is sought.

The cover may have any suitable shape. In this illustrated embodiment, cover 101 has a three-dimensional substantially rectangular shape. The shape of cover 101 comprises upwardly extending sides 104, and a substantially flat top 105. In this example, the upwardly extending sides 104 slope inwardly towards the flat top 105. In this embodiment, the cover 101 defines a plurality of apertures 103 in a spaced apart arrangement on at least one of the upwardly extending sides 104 of the three-dimensional substantially rectangular shape.

The cover may be made of any suitable self-supporting material or combination of self-supporting materials. The cover may be manufactured by any suitable process or combination of processes. Advantageously, the cover may be made of an at least partially resilient and/or flexible material. With such a material, permanent damage to or deformation of the cover is prevented in the event that the cover accidentally hits or is hit by another object during cooking or handling, or in the event that the cover accidentally drops onto a hard surface. In an embodiment, the cover is made of a metallic sheet or foil material, such as aluminium or steel. In an example, the cover is formed using a pressing operation, to form the cover from a single sheet of a metal material. It is to be appreciated that the cover may be made of a non-metallic material. In an embodiment, the cover is made of a heatproof plastics material, such as silicone.

The cover may be provided with a surface coating. Advantageously, the cover may be provided with a surface coating that renders the cover easier to clean and/or hardens the cover surfaces to protect against damage. In an embodiment, the cover is provided with a Teflon™ coating so as to reduce the risk of food products becoming stuck to the cover.

In this illustrated embodiment, cover 101 is made of a partially resilient and self-supporting sheet-like material, such as aluminium, and is formed by pressing the self-supporting sheet-like material into the desired shape.

The cover may be provided with an engagement arrangement configured to releasably engage the cooking tray. The engagement arrangement may have any suitable arrangement for keeping the cover in engagement with the cooking tray. The engagement arrangement advantageously serves to maintain the cover securely in position relative to the cooking tray. This feature functions to improve the safety of handling of the cooking tray with cover, since the cooking tray, and by extension the cover, and also the food product within, are likely to become very hot during the cooking process. There is thus a likelihood of injury or damage if the cover were to be accidentally dislodged from the cooking tray.

The engagement arrangement of the cover may be specifically configured for a particular type or size of cooking tray. Alternatively, the engagement arrangement of the cover may be configured so as to engage with each of a variety of different cooking trays. In an embodiment, the engagement arrangement takes the form of a raised edge or lip around the edges of the cover. The shape of the raised edge or lip may match or partially match the shape of the edge of the cooking tray. With this arrangement of engagement arrangement, when the cover is mounted on the cooking tray, the raised edge or lip prevents the cover from sliding relative to the cooking tray. The engagement arrangement may be provided with features or formations so as to prevent liquid from escaping from the cooking tray and/or so as to cause liquid to drip into the cooking tray.

In this illustrated embodiment, the cover 101 has an engagement arrangement comprising an edge portion 106 configured to be located onto the edge 107 of the cooking tray 102, so as to restrict the cover 101 from sliding relative to the cooking tray 102 when mounted thereon. A groove 108 is formed along the inner edge of the edge portion 106, which functions to prevent condensation droplets or other liquids passing between the cover 101 and the cooking tray 102, whether into or from the food product containing space defined between the cover 101 and the cooking tray 102.

The engagement arrangement may comprise a locking arrangement for releasably locking the cover into engagement with the cooking tray. The locking arrangement may take any suitable form. A suitable locking arrangement may comprise a catch, a latch or a clasp. In an embodiment, the locking arrangement is configured to allow access to a food product within the space between the cover and the cooking tray without requiring the cover to be detached from the cooking tray. Such a locking arrangement may comprise a hinge or a resilient element.

The cover may comprise at least one handle, comprising at least one handle for facilitating manual handling thereof. In this illustrated embodiment, cover 101 comprises a pair of handles 109, 110. In the shown arrangement, the handles 109, 110 are located one at each end 111, 112 of the three-dimensional substantially rectangular shape. In an embodiment, the handles are made from a metal material, such as aluminium or steel. In an example, the handles are made from wire that is bent and stamped to create a flange with rivet apertures and any other desired features. In an embodiment, the cover and the cover handles are made from the same metal material.

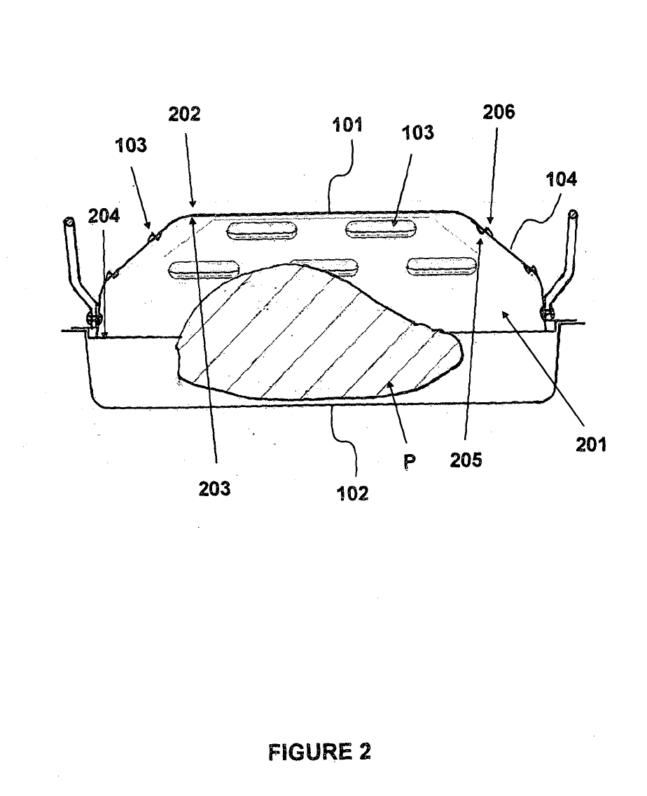

FIG. 2

FIG. 2 shows cover 101 mounted on cooking tray 102 and with a food product P located within the space 201 between the cover 101 and the cooking tray 102. The food product P may be any type of product. The cover 101 is suitable for use with a joint of meat, for example, beef, pork or chicken.

As previously mentioned, the cover 101 defines a plurality of apertures 103 therein. The cover 101 is configured to prevent fluids from escaping the cooking tray 102, whilst allowing excess moisture to escape.

The apertures of the cover may have any suitable shape or dimensions for enabling vapour, in particular evaporated water, to pass therethrough whilst preventing fluids from escaping the cooking tray. The shape of the apertures defined in the cover may be substantially rectangular, substantially circular, substantially oval or any other suitable geometric shape. In an embodiment, the apertures are formed so as to present substantially linear slits in the cover. It is to be appreciated that apertures of different shapes and/or different dimensions may be defined in the cover.

The apertures of the cover may be positioned in any suitable configuration. In an embodiment, the apertures are arranged in a regular pattern. The regular pattern may be a triangular, a rectangular or hexagonal pattern. The apertures may be arranged in rows or lines. The apertures may alternatively be arranged in an irregular pattern. It is to be appreciated that the cover may define apertures in a regular pattern in one region and define apertures in an irregular pattern in another region.

The apertures of the cover are so configured as to prevent fluids, such as food juices and condensation droplets, from exiting the space between the cover and the cooking tray and contaminating the surrounding surfaces, yet to allow the exit of vapour from excess moisture within the space between the cover and the cooking tray.

As will be described in further detail, each of the plurality of apertures defined in the cover has a pair of edges, and at least one of the pair of edges extends inwardly or outwardly relative to the surface of the cover.

Cover 101 has a surface having an upper side 202 and an underside 203 and defines a plurality of apertures 103 enabling vapour to pass therethrough. In this illustrated embodiment, each of the plurality of apertures 103 defined in the cover 101 extends substantially linearly. Each of the apertures 103 extends substantially parallel to an edge 204 of the cover 101. As shown, the apertures 103 are arranged in a regular pattern in a pair of horizontally offset and vertically spaced rows. It is to be appreciated however that any number of rows of apertures may be provided in the cover. The apertures of the cover may be formed by any suitable technique or combination of techniques. The apertures may be provided by pressing, cutting or drilling.

In this illustrated embodiment, each aperture 103 of cover 101 is formed by making a substantially linear cut through the cover 101 and bending at least one of a pair of edges formed by the cut in the cover 101. In an example, each aperture is formed in a single operation using a press tool. In the shown arrangement, one edge 205 of each aperture 103 of cover 101 is so bent as to extend inwardly relative to the surface of the cover, and the other edge 206 of each aperture 103 of cover 101 is so bent as to extend outwardly relative to the surface of the cover.

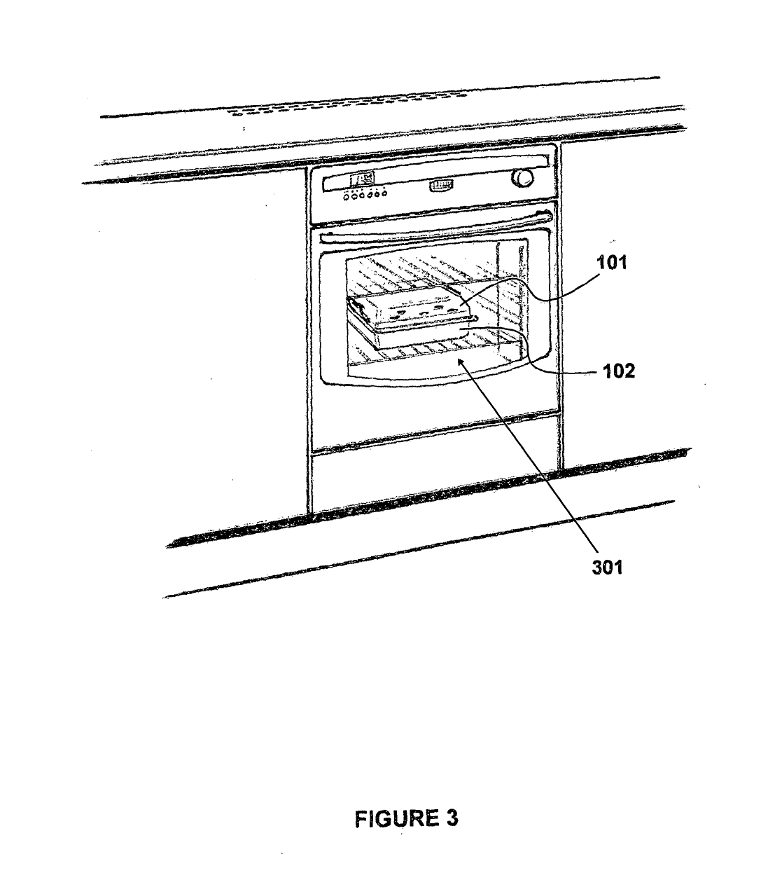

FIG. 3

In FIG. 3, the cover 101 is shown mounted on cooking tray 102 and in use within an oven 301. The oven may be any type of oven, such as may be used in a domestic or commercial residence. The oven will typically have one or more internal elements, such as a heating element and fan, which are located at the rear of the oven and are exposed to the main cavity of the oven.

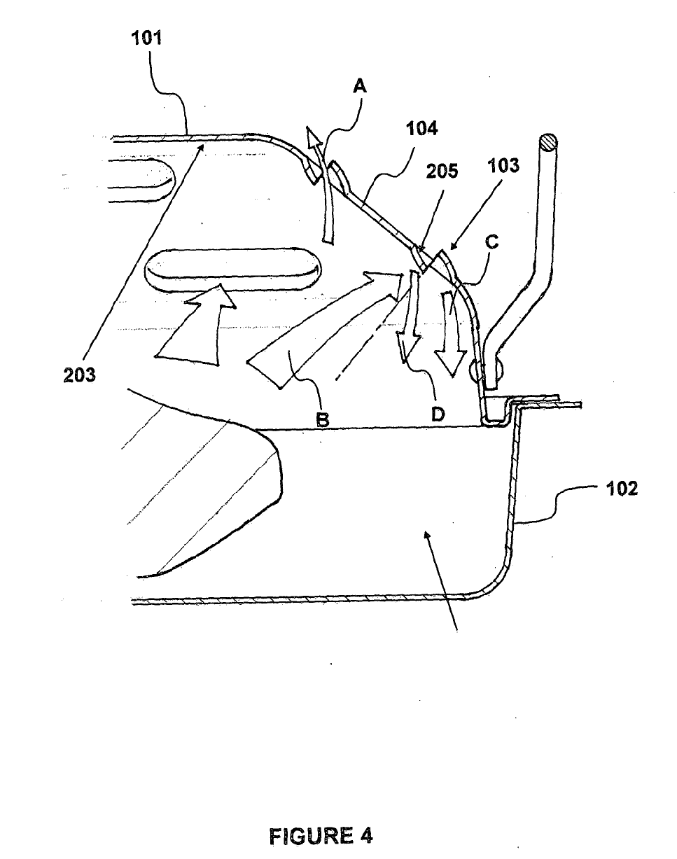

FIG. 4

The functionality of the cover 101 when in use is illustrated in FIG. 4. During the cooking process, part of the vapours created will escape through the apertures 103 defined in the cover 101, as indicated by arrow A. Another part of the vapours created will form as condensation droplets on the underside 203 of the cover 101, as indicated by arrow B. Over time, the condensation droplets will tend to grow, until such a time when gravity will force them to move, either by propagating along an inclined portion of underside 203 of the cover 101 or by falling off the underside 203 of the cover, as indicated by arrows C and D. With reference to upwardly extending wall 104 of the cover, as the inside surface is inclined, droplets will, upon reaching a certain size, propagate downwards, until they arrive at the upper edge 205 of aperture 103. As each individual droplet cannot propagate further along the inside surface of the upwardly extending wall 104, it will be stopped, to form together with other droplets to create a larger droplet that, on reaching a certain size, will drip from the upper edge 205 of aperture 103 into the cooking tray 102 below.

As is to be appreciated, vapour is allowed to flow out above the cover 101 whilst moisture droplets are retained under the cover 101. In this way, excess moisture in the form of vapour is removed whilst potential liquid splashes are contained. This advantageously prevents contamination of surrounding surfaces and at the same time prevents the food product being cooked from becoming soggy. The cover 101 functions to allow evaporated water to escape yet to retain fat within the cooking tray 102.

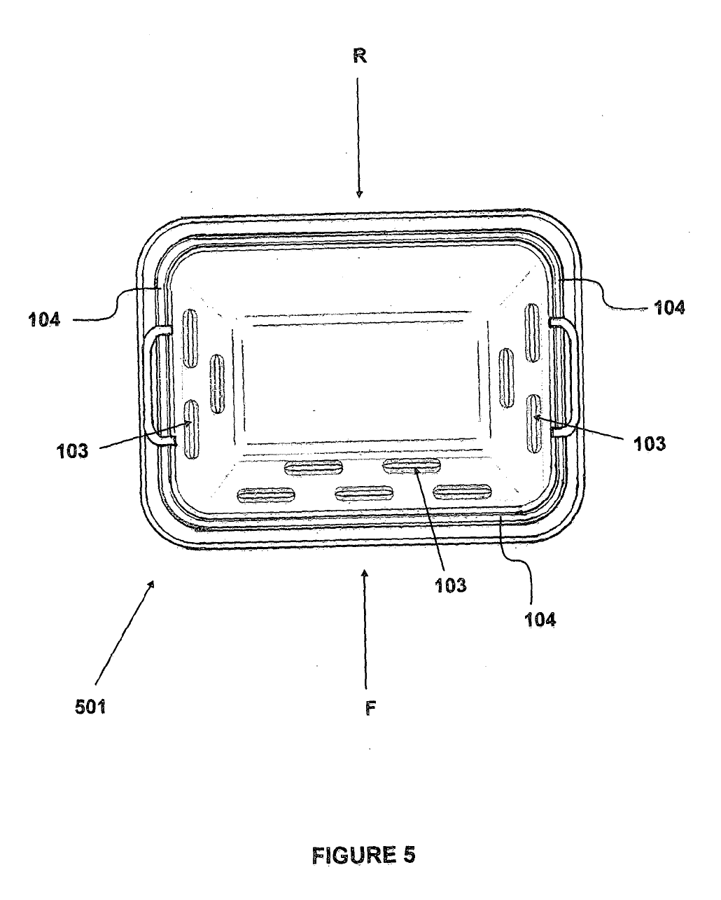

FIG. 5

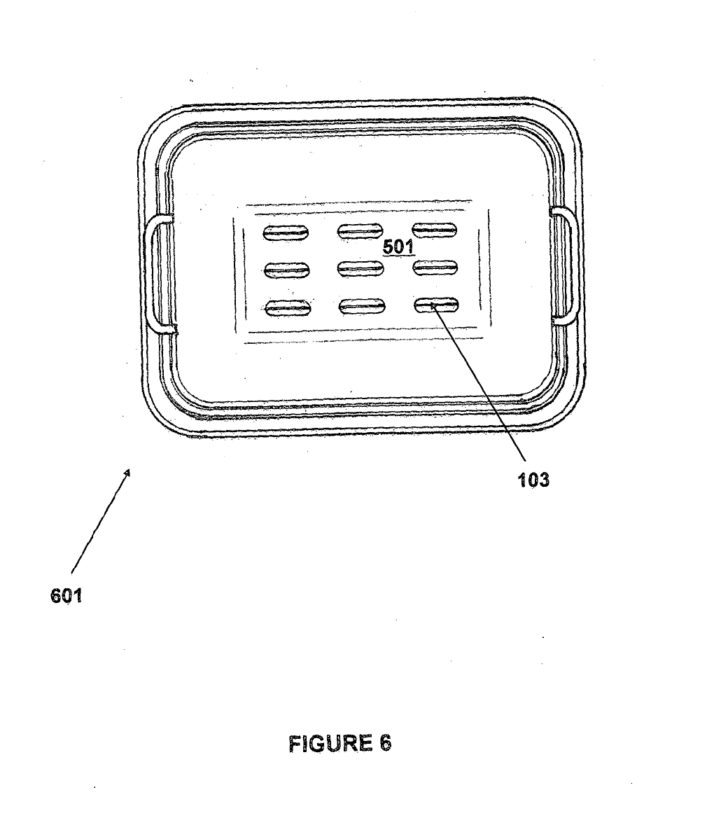

A second cover 501 for a cooking tray is shown in FIG. 6. Cover 501 is similar to cover 101 in all aspects except in the different aspects as will now be described. In the shown arrangement, the cover 501 has a partial region of the cover 501 that does not have any apertures defined therein. In this illustrated embodiment, only three of the four sides 104 of the three-dimensional substantially rectangular shape of the cover 501 define apertures 103 therein, such that one side of the cover 501 presents a solid surface. This allows the cover 501 to be placed within a fan oven with the solid rear side R of the cover 501 orientated towards the fan at the rear of the oven and the opposed aperture side F of the cover 501 orientated towards the front of the oven. In use, the solid rear side R of the cover 501 prevents air flow created by the operational oven fan from entering the space between the cover and the cooking tray. This serves to prevent blockage of the apertures 103, which may occur if air flow from the oven fan pushes droplets or pieces of food product within the space between the cover and the cooking tray into or over an aperture 103 in the cover. In addition, the solid rear side R of the cover 501 prevents evaporating moisture escaping the cover from being directed towards the rear of the oven, where the heating element is located.

FIG. 6

A third cover 601 for a cooking tray is shown in FIG. 6. Cover 601 is similar to cover 101 in all aspects except in the different aspects as will now be described. In the shown arrangement, only the flat top 105 of the three-dimensional substantially rectangular shape of the cover 601 defines apertures 103. It is to be appreciated that a cover having the three-dimensional substantially rectangular shape of cover 101 and third cover 601 may define apertures in one or all of the upwardly extending side walls 104 thereof and also define apertures in the flat top 105 thereof.

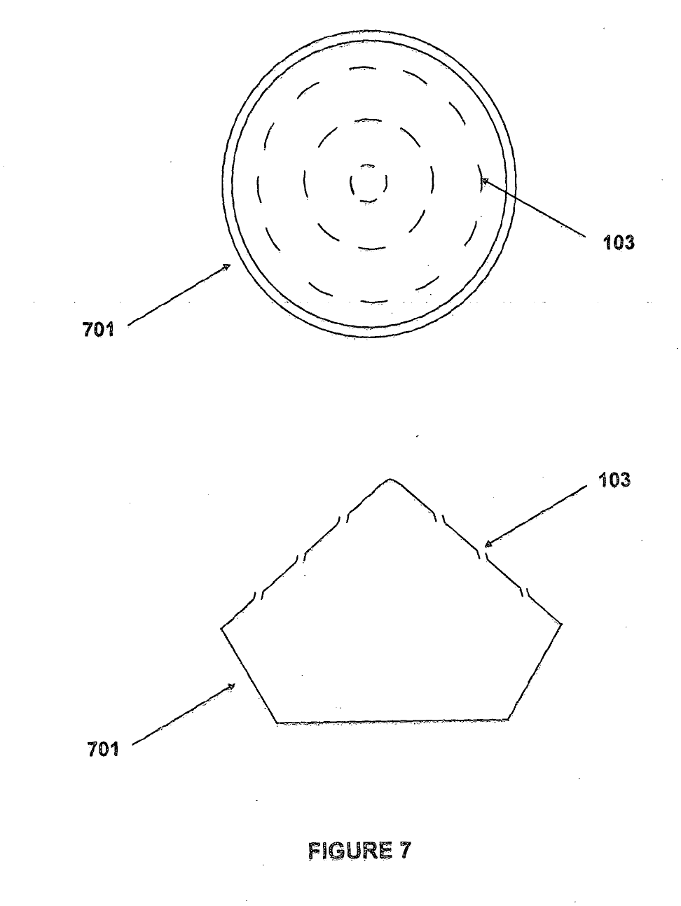

FIG. 7

A fourth cover 701 for a cooking tray is shown in FIG. 7. Cover 701 has a similar functionality to cover 101, second cover 501 and third cover 601; however cover 701 has a substantially conical shape with a rounded top and defines apertures 103 all the way around the substantially circular circumference thereof. The apertures 103 of fourth cover 701 are substantially arcuate. As previously mentioned, the apertures may however be any suitable non-linear shape.

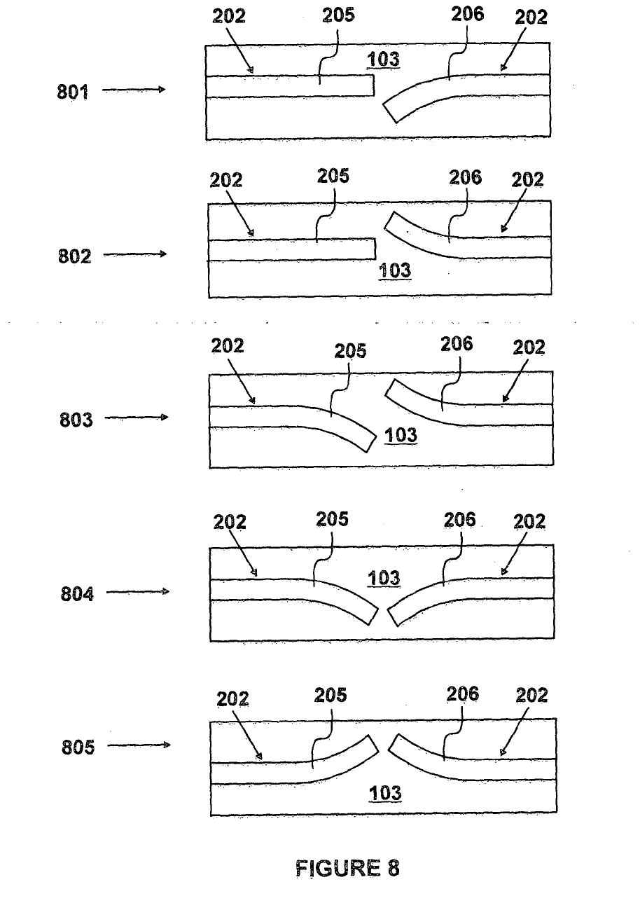

FIG. 8

FIG. 8 shows different arrangements of a pair of edges of an aperture defined by a cover for a cooking tray, in which at least one of the pair of edges of the aperture extends inwardly or outwardly relative to the surface of the cover.

At 801, an arrangement is shown in which edge 205 of aperture 103 extends substantially in the same plane as the surface of the cover and the opposed edge 206 of the aperture 103 extends inwardly relative to the surface of the cover.

In the arrangement shown at 802, edge 205 of aperture 103 extends substantially in the same plane as the surrounding surface of the upper side 202 of the cover and the opposed edge 206 of the aperture 103 extends outwardly relative to the upper side 202 of the cover.

According to the arrangements shown at 801 and 802, one of the pair of opposed edges of the aperture extends in the same plane as the surface of the cover and the other of the pair of opposed edges of the aperture extends in an inclined plane relative to the surface of the cover.

At 803, an arrangement is shown in which one of the pair of edges 205, 206 of aperture 103 extends inwardly relative to the surface of the cover and the other of the pair of opposed edges 205, 206 of the aperture 103 extends outwardly relative to the surface of the cover. In the shown example, edge 205 extends inwardly relative to the surface of the cover and edge 206 extends outwardly relative to the surface of the cover, but this may be the other way around with edge 205 extending outwardly relative to the surface of the cover and with edge 206 extending inwardly relative to the surface of the cover.

According to the arrangement shown at 803, one of the pair of edges of the aperture extends in an inclined plane relative to the surface of the cover the other of the pair of opposed edges of the aperture extends in a parallel inclined plane relative to the surface of the cover. It is to be appreciated however that the opposed edges of the aperture may extend, one inwardly and one outwardly relative to the surface of the cover, in non-parallel inclined planes relative to the surface of the cover.

In the arrangement shown at 804, both of the pair of edges 205, 206 of aperture 103 extend inwardly relative to the surface of the cover.

In the arrangement shown at 805, both of the pair of edges 205, 206 of aperture 103 extend outwardly relative to the surface of the cover.

According to the arrangements shown at 804 and 805, the edges of the aperture extend, either both inwardly or both outwardly relative to the surface of the cover, in inclined planes relative to the surface of the cover that are substantially in mirror image. It is to be appreciated however that the opposed edges of the aperture may extend, either both inwardly or both outwardly relative to the surface of the cover, in inclined planes relative to the surface of the cover that are not substantially in mirror image.

It is to be understood that in each of the arrangements shown in 801, 802, 803, 804 and 804 the aperture 103 has a pair of edges 205, 206, and each edge of the pair of edges 205, 206 extends at a different angle to the other of the pair of edges.

A cover for a cooking tray as described herein may define a plurality of apertures in which each aperture has a pair of edges having the same or a different arrangement as a pair of edges of another or each other aperture.

A cover for a cooking tray as described herein advantageously serves to prevent contamination of internal parts of an oven and to allow moisture to evaporate through vents in the cover. When cooking meat, the cover beneficially acts to retain fat within the cooking tray yet to allow water to evaporate away from the cooking tray, to provide cooked meat that is moist, succulent and crispy. A cover for a cooking tray as described herein prevents smoke forming in the kitchen and keeps the oven clean and free from smells. A cover for a cooking tray as described herein is easily cleaned, without the need for use of environmentally damaging harsh chemicals.

A cover for a cooking tray as described herein prevents spatter build-up on oven walls and floor. Use of a cover for a cooking tray as described herein beneficially prevents the development of ‘hot spots’ on oven heating elements that are formed by splashes of spitting fat, and which cause premature oven breakdown. Thus, use a cover for a cooking tray as described herein can also prolong the working life of an oven.

A cover for a cooking tray as described herein is more convenient to use than metallic foil, which can be fiddly to handle. A cover for a cooking tray as described herein is more convenient and can also be used mutt pie times, thereby reducing the waste associated with metallic foil, which is typically only used once before disposal.

A cover for a cooking tray may be provided with a cooking tray with which the cover may be used. Advantageously, the cover is configured to be upturned and placed within the cooking tray, in a compact, nested arrangement, for convenient storage.

1. A cover for use with a cooking tray, said cover so locatable relative to said cooking tray as to form a self-supporting roof thereover,
said cover having a surface having an upper side and an underside and defining a plurality of apertures enabling vapour to pass therethrough,
each of said plurality of apertures having a pair of edges, and
wherein at least one edge of said pair of edges extends inwardly or outwardly relative to the surface of the cover.

2. A cover as claimed in claim 1, wherein one of said pair of side edges extends substantially in the same plane as the surface of the cover and the other of said pair of edges extends inwardly relative to the surface of the cover.

3. A cover as claimed in claim 1, wherein one of said pair of side edges extends substantially in the same plane as the surface of the cover and the other of said pair of edges extends outwardly relative to the surface of the cover.

4. A cover as claimed in claim 1, wherein one of said pair of side edges extends inwardly relative to the surface of the cover and the other of said pair of edges extends outwardly relative to the surface of the cover.

5. A cover as claimed in claim 1, wherein each of said plurality of apertures extends substantially linearly.

6. A cover as claimed in claim 5, wherein each of said plurality of apertures extends substantially parallel to an edge of said cover.

7. A cover as claimed in claim 6, wherein said cover defines a plurality of apertures in an upwardly extending surface thereof and the upper edge of each of the plurality of apertures defined in said upwardly extending surface extends inwardly relative to the surface of the cover.

8. A cover as claimed in claim 1, comprising an engagement arrangement adapted to releasably engage with said cooking tray.

9. A cover as claimed in claim 8, wherein said engagement arrangement comprises an edge portion configured to be located onto the edge of the cooking tray, so as to restrict the cover from sliding relative to the cooking tray when mounted thereon.

10. A cover as claimed in claim 8, further comprising a locking arrangement for releasably locking the cover into engagement with the cooking tray.

11. A cover as claimed in claim 10, wherein said locking arrangement is configured to allow access to a food product within the space between the cover and the cooking tray without detaching the cover from the cooking tray.

12. A cover as claimed in claim 1, comprising at least one handle for facilitating manual handling thereof.

13. A cover as claimed in claim 12, comprising a pair of handles.

14. A cover as claimed in claim 1, comprising a region that does not define any apertures therein.

15. A cover as claimed in claim 1, made from one of: a metal material, a plastics material.

16. (canceled)
